(19) United States
(12) Patent Application Publication
(10) Pub. No.: US 2013/0120309 A1
(43) Pub. Date: May 16, 2013

(54) TOUCH DETECTION METHOD FOR CAPACITIVE TOUCH SCREENS AND TOUCH DETECTION DEVICE

(71) Applicant: Lianghua Mo, Shenzhen (CN)

(72) Inventor: Lianghua Mo, Shenzhen (CN)

(73) Assignee: FOCALTECH SYSTEMS, LTD., George Town (KY)

(21) Appl. No.: 13/467,443

(22) Filed: May 9, 2012

(30) Foreign Application Priority Data
Nov. 16, 2011 (CN) 201110364018.6

(51) Int. Cl. G06F 3/044

(52) U.S. Cl. 345/174

(57) ABSTRACT

A touch detection method for capacitive touch screens, includes: generating a waveform signal and transmitting the waveform signal to a capacitor under detection, by a transmitting end; converting the waveform signal transmitted by the transmitting end into charges, and transferring the charges to a detection circuit, by the capacitor under detection; and receiving the charges transferred by the capacitor under detection, generating an output signal, determining whether the touch takes place by performing detection processing on the output signal, and resetting the output signal of the detection circuit to a reference level prior to a variation in an edge of the waveform signal, by the detection circuit, where a phase clock of the detection circuit and a phase clock of the transmitting end are kept synchronous.

This application claims the priority of Chinese Patent Application No. 201110364018.6, entitled “TOUCH DETECTION METHOD FOR CAPACITIVE TOUCH SCREENS AND TOUCH DETECTION DEVICE”, filed on Nov. 16, 2011 with State Intellectual Property Office of PRC, which is hereby incorporated by reference in its entirety.

### FIELD OF THE INVENTION

The present invention relates to the field of capacitive touch screens, and in particular to touch detection method for capacitive touch screens and touch detection device.

### BACKGROUND OF THE INVENTION

The technology of capacitive touch detection is to determine whether a touch takes place by a variation in the capacitance of a capacitor under detection. Capacitance, which originally exists between any two isolated conductors, would be changed due to the change of original electric field if a human being or a touching object serves as a third conductor.

In the prior art, there exists a touch detection method, in which the capacitor is taken as a charge container to be charged and discharged, and then the capacitance is determined by detecting related signals. For example, the capacitor is taken as energy storage of a relaxation oscillator and is charged with constant current. When the voltage across the capacitor exceeds a reference voltage, the output will be reversed. Then the control switch is closed to discharge the capacitor. After the discharging, the control switch is opened, and the voltage across the capacitor continues to go up. The process is repeated again and again, so that an oscillator is formed. This kind of capacitive touch device is prone to be interfered for being generally exposed to the environment, especially for being often used in complicated electric-magnetic environment and power supply environment. In measuring the capacitance by the method of the relaxation oscillator, the external interference may affect the system without any restraint, which will cause a low signal-to-noise ratio in the touch detection device.

With the development of technology, a touch detection method adopting triple-frequency continuous scan is proposed, in which each of the frequencies is modulated and demodulated separately; by demodulation of a mixer, signal is converted into direct current for process; judgment is performed among the multiple frequencies and noise if filtered. This method basically solves the problem of noise interference; however it is very time-consuming and hardware-costly to scan with three frequencies simultaneously. Further, for some touch screens which are less costly, more suitable for commercial use and more desirable for the future trend of ultra-thin screens, this method may cause noise accumulation in performing touch detection, and in order to improve the anti-noise saturation capability, the charge amplifier adopts relatively great feedback capacitance which however decreases the signal-to-noise ratio of the system.

### SUMMARY OF THE INVENTION

The present invention provides a touch detection method for capacitive touch screens and a touch detection device, which may detect a touch that takes place on a capacitor under detection, and may enable a saved hardware cost and an improved anti-noise performance of the system.

An embodiment of the present invention provides a touch detection method for capacitance touch screens, which includes:

generating a waveform signal to be transmitted, and transmitting the waveform signal to a capacitor under detection, by a transmitting end;

converting the waveform signal transmitted by the transmitting end into charges, and transferring the charges to a detection circuit, by the capacitor under detection, where when a touch takes place, the capacitance of the capacitor under detection changes and a quantity of the charges transferred to the detection circuit also changes; and

receiving the charges transferred by the capacitor under detection, generating an output signal, determining whether the touch takes place by performing detection processing on the output signal, and resetting the output signal of the detection circuit to a reference level prior to a variation in an edge of the waveform signal, by the detection circuit, where a phase clock of the detection circuit and a phase clock of the transmitting end are kept synchronous.

Preferably, resetting the output signal of the detection circuit to a reference level prior to variation in an edge of the waveform signal by the detection circuit includes:

closing and then opening a switch with a nanosecond-scale high-level pulse wave in a frequency higher than the frequency of the waveform signal prior to the variation in the edge of the waveform signal, by the detection circuit.

Preferably, performing detection processing on the output signal by the detection circuit includes:

performing high-speed sampling and holding on the output signal, performing weighting and filtering on the sampled and hold signal, and converting the weighted and filtered signal into a digital signal, by the detection circuit, to determine whether the touch takes place.

Preferably, the weighting and filtering includes: windowing the output signal in continuous domain or in digital domain or in sampling data domain.

Preferably, the waveform signal includes any one of continuous square wave, continuous trapezoidal wave, continuous sine wave, continuous cosine wave, and continuous triangular wave.

An embodiment of the present invention provides a touch detection device, which includes: a transmitting end, a capacitor under detection, and a detection circuit, where

the transmitting end is adapted to generate a waveform signal to be transmitted and transmit the waveform signal to the capacitor under detection;

the capacitor under detection is adapted to convert the waveform signal transmitted by the transmitting end into charges, and transfer the charges to the detection circuit, where when a touch takes place, the capacitance of the capacitor under detection changes and a quantity of the charges transferred to the detection circuit also changes; and

the detection circuit is adapted to receive the charges transferred by the capacitor under detection, generate an output signal, determine whether the touch takes place by performing detection processing on the output signal, and reset the output signal of the detection circuit to a reference level prior to a variation in an edge of the waveform signal, where a phase clock of the detection circuit and a phase clock of the transmitting end are kept synchronous.

Preferably, the transmitting end includes a waveform generator and a transmitter,

the waveform generator is adapted to generate the waveform signal to be transmitted; and

the transmitter is adapted to transmit the waveform signal to the capacitor under detection.

Preferably, the detection circuit includes: a charge amplifier with a resetting element and a feedback capacitor, an over-sampling and holding circuit, a weighting and filtering circuit and an analog-to-digital converter, where the charge amplifier with the resetting element and the feedback capacitor is adapted to receive the charges transferred by the capacitor under detection, generate the output signal and reset the output signal to the reference level prior to the variation in the edge of the waveform signal;

the over-sampling and holding circuit is adapted to perform high-speed sampling and holding on the output signal;

the weighting and filtering circuit is adapted to window the output signal in continuous domain or in digital domain or in sampling data domain; and

the analog-to-digital converter is adapted to convert the output signal into a digital signal and output the digital signal, to determine whether the touch takes place.

It can be seen from the above technical solutions that the embodiments of the present invention have the following advantages.

In the embodiments of the present invention, at arrival of the edge of the waveform signal, the capacitor under detection is charged and discharged, and the quantity of electric charges is transmitted to the detection circuit. Because the detection circuit resets the output signal to the reference level prior to the variation in the edge of the waveform signal, the accumulation of the noise signal can be avoided, the saturation of the output signal is decreased, and the anti-noise performance of the system is improved. Further, in implementing the touch detection method for the capacitive touch screens provided by the present invention, it is unnecessary to scan with three frequencies simultaneously, therefore the total detection time can be decreased, and no additional hardware cost is required. According to the method provided by the embodiment of the present invention, when a touch takes place, variation in the capacitance of the capacitor under detection will be caused. By detecting the variation, it may be determined whether the touch takes place, and if the touch takes place, the coordinates of the touch may be calculated.

### BRIEF DESCRIPTION OF THE DRAWINGS

Technical solutions of the embodiments of the present applicant will be illustrated more clearly with the following brief description of the drawings. Apparently, the drawings referred in the following description constitute only some embodiments of the invention. Those skilled in the art may obtain some other drawings from these drawings without any inventive labor.

FIG. 1 is a schematic diagram of an embodiment of a touch detection method for capacitive touch screens provided by an embodiment of the present invention;

FIG. 2 is a schematic diagram of a charge amplifier in the prior art;

FIG. 3 is a schematic diagram of a charge amplifier with a resetting element and a feedback capacitor provided by an embodiment of the present invention;

FIG. 4 is a schematic diagram of constitution of a detection circuit provided by an embodiment of the present invention;

FIG. 5 is a schematic simulation diagram of an example of output signals in the touch detection method for capacitive touch screens provided by an embodiment of the present invention and in the prior art;

FIG. 6 is a schematic simulation diagram of another example of output signals in the touch detection method for capacitive touch screens provided by an embodiment of the present invention and in the prior art;

FIG. 7 is an amplified schematic diagram of A portion in FIG. 6;

FIG. 8 is a schematic diagram of an embodiment of a touch detection device provided by an embodiment of the present invention; and

FIG. 9 is a schematic diagram of another embodiment of a touch detection device provided by an embodiment of the present invention.

### DETAILED DESCRIPTION OF THE INVENTION

The present invention provides a touch detection method for capacitive touch screens and a touch detection device, which may detect a touch that takes place on a capacitor under detection, and may enable a saved hardware cost and an improved anti-noise performance of the system.

The technical solutions of the embodiments of the present invention will be described clearly and completely in conjunction with the drawings, to make the objectives, features, and advantages of the present invention clearer and more comprehensive. Apparently, the described embodiments are only some rather than all embodiments of the present disclosure. Any other embodiments obtained from the embodiments of the present disclosure by those skilled in the art without any inventive labor fall within the scope of the invention.

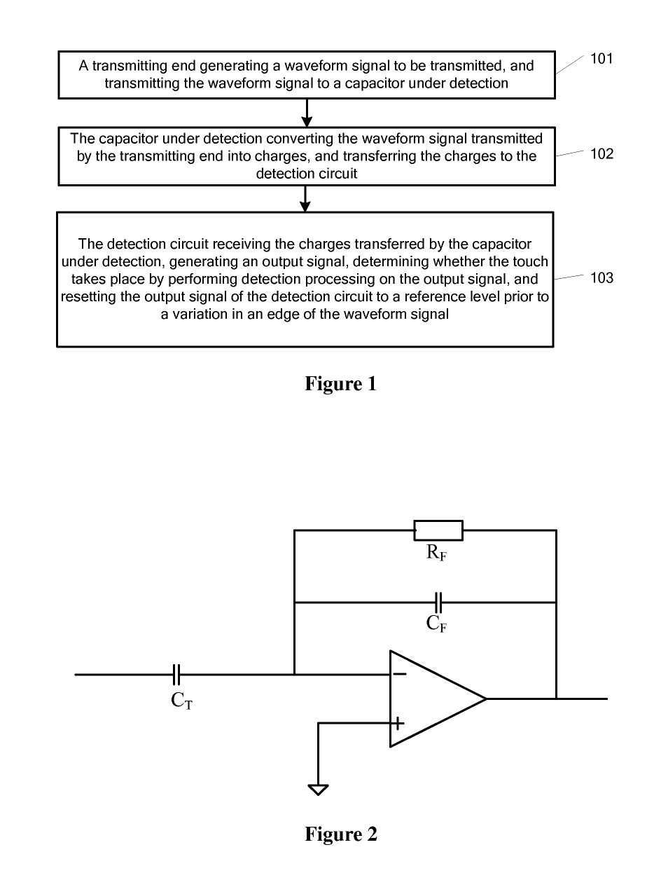

A touch detection method for capacitive touch screens provided by an embodiment of the present invention, as shown in FIG. 1, includes:

101. A transmitting end generating a waveform signal to be transmitted, and transmitting the waveform signal to a capacitor under detection.

In an embodiment of the present invention, a phase clock of the transmitting end and a phase clock of a detection circuit are kept synchronous. In an embodiment of the present invention, the transmitting end firstly generates a waveform signal to be transmitted and transmits this waveform signal to a capacitor under detection. In practice, the waveform signal generated by the transmitting end may include square wave, trapezoidal wave, sine wave, cosine wave, triangular wave and the like. The adopted waveform signal is not limited herein.

In the embodiment of the present invention, the transmitting end may include a waveform generator and a transmitter. The waveform generator may generate the waveform signal to be transmitted, and the phase clock of the waveform generator and the phase clock of the detection circuit must be kept synchronous. The transmitter performs level shift, increasing driving capacity and edge control on the waveform signal transmitted from the waveform generator.

102. The capacitor under detection converting the waveform signal transmitted by the transmitting end into charges, and transferring the charges to the detection circuit.

When a touch takes place, the capacitance of the capacitor under detection changes and a quantity of the charges transferred to the detection circuit also changes.

In an embodiment of the present invention, transfer of charges occurs regardless whether a touch takes place. If the touch takes place, the capacitance of the capacitor under detection on the touch screen will change, and the quantity of the charges transferred will change. By detecting the variation in the quantity by the detection circuit, the variation in the capacitance will be known, so that whether the touch takes place may be determined and the coordinates of the touch may be calculated by the detection circuit.

In an embodiment of the present invention, when a finger of a human being or any other object touches the capacitive touch screen, the capacitance of the capacitor under detection at the touched point changes, and the capacitor under detection will generate charges and transmit the charges to the detection circuit, where the capacitor under detection is integrated on the capacitive touch screen.

103. The detection circuit receiving the charges transferred by the capacitor under detection, generating an output signal, determining whether the touch takes place by performing detection processing on the output signal, and resetting the output signal of the detection circuit to a reference level prior to a variation in an edge of the waveform signal.

The phase clock of the detection circuit and the phase clock of the transmitting end are kept synchronous.

In an embodiment of the present invention, upon receiving the charges transmitted by the capacitor under detection, the detection circuit transmits the output signal to a touch controller of the capacitive touch screen for being identified by the touch controller as touch information.

In an embodiment of the present invention, the detection circuit resets the output signal of the detection circuit to the reference level prior to the variation in the edge of the waveform signal, so that the accumulation of the noise signal can be avoided, the saturation of the output signal is decreased, and the anti-noise performance of the system is improved.

In practice, one feasible way for the detection circuit to reset the output signal of the detection circuit to the reference level prior to the variation in the edge of the waveform signal may include: the detection circuit closing and then opening a switch with a nanosecond-scale high-level pulse wave in a frequency higher than the frequency of the waveform signal prior to the variation in the edge of the waveform signal.

In practice, one feasible way for the detection circuit to perform detection processing on the output signal may include: the detection circuit performing high-speed sampling and holding on the output signal, performing weighting and filtering on the resulted signal, and converting the resulted signal into a digital signal, so as to determine whether touch takes place.

In an embodiment of the present invention, the detection circuit may include a charge amplifier with a resetting element and a feedback capacitor, an over-sampling and holding circuit, a weighting and filtering circuit and an analog-to-digital converter. The charge amplifier may receive the charges transferred by the capacitor under detection and amplify and convert the charges into a voltage signal. The resetting element in the charge amplifier, which is in a parallel arrangement, is able to reset the output signal to the reference level prior to the variation of the edge of the waveform signal.

The charge amplifier provided by the embodiment of the present invention is different from the charge amplifier in the prior art. The charge amplifier in the prior art has a high-pass feedback resistor, and is adapted to convert the charges transmitted from the capacitor under detection into a voltage to be processed by the next stage, and to determine the direct current operating point of the circuit due to the integrated high-pass feedback resistor. Unfortunately, if there is a low-frequency coupling (for example, several tens of Hz to tens of KHz) with relatively high amplitude for this charge amplifier, the detection circuit is prone to be saturated. And if the detection circuit is saturated, the real signal will be swamped and can not be detected. The detection circuit in the prior art is shown in FIG. 2, where C_{T} is the capacitor under detection, R_{F} is the high-pass resistor, and C_{F} is the feedback capacitor. When ignoring the high-pass resistor, the detection circuit in the prior art is a capacitive proportional amplifier for amplifying the input signal in a proportion of C_{T}/C_{F}. If the input signal is too high, the output signal will be saturated. To decrease the saturation, the high-pass resistor R_{F} is added into the detection circuit. The R_{F} feeds the output signal back to the inverse input end of the amplifier, and in the case of the output signal departing from a central value, the amplitude of the output signal will be decreased thanks to the superposition of feeding back the signal to the inverse input end of the amplifier. The high-pass resistor and the C_{T} form a high-pass circuit for better restraining low-frequency signals but passing the signal needed to be operated. For example, signal in the range of 100 KHz˜300 KHz may be passed without any attenuation by means of suitable parameter design. However, this is merely a first-order high-pass filter with very poor filtering effect;

the high-pass resistor is integrated inside the chip with a great deviation, for example of 20%; and the variation of the C_{T} outside the chip is also relatively great, for example from 1 pF to 4 pF. Therefore, to ensure that the signal in the range of 100 KHz˜300 KHz will be passed normally, the bandwidth will generally be designed relatively wide, for example being 20 KHz˜1 MHz. Thus, on one hand this filter has bad restraint effect for low-frequency signal, and on the other hand many interfering signals, for example interfering signals of 10 KHz˜100 KHz, may be passed substantially without any attenuation since the pass-band is designed much wider than practical required. Much interference takes place in the frequency band of 10 KHz˜100 KHz, and the amplitude is very great, thus signal saturation is very prone to be caused.

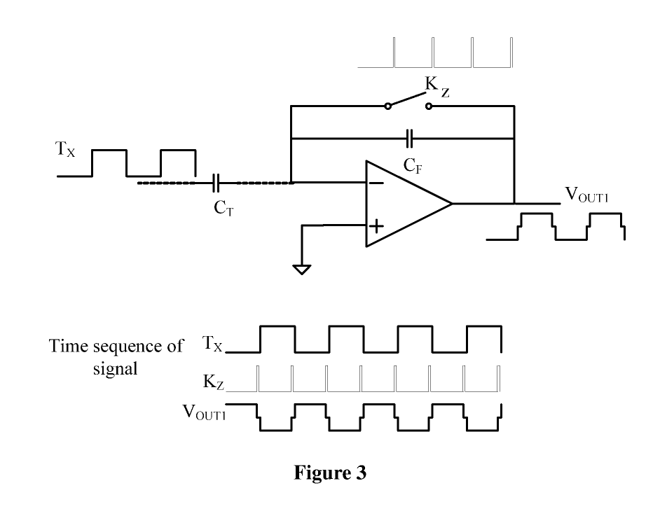

The charge amplifier with a resetting element and a feedback capacitor provided by an embodiment of the present invention is shown in FIG. 3, where C_{T} is the capacitor under detection, C_{F} is the feedback capacitor, the square wave transmitted by the transmitter is a periodic signal T_{X}, and K_{Z} of the resetting element is a nanosecond-scale high-level pulse wave (i.e., the high level lasts for a short period, for example of 100 nS). The pulse will arrive once every time before the variation in the edge of the T_{X} square wave takes place, and the pulse closes and then opens the switch. Once the switch is closed, the output signal is reset to the reference level. Due to the relatively high frequency, for example 100 KHz˜300 KHz, of the T_{X}, and the resetting frequency of 200 KHz˜600 KHz of K_{Z}, signals with tens of KHz frequency will be eliminated by the K_{Z} signal rather than being accumulated, so that the low-frequency saturation is avoided. For example, for an interfering signal of a sine wave having an amplitude of 30V and a frequency of 10 KHz, and the T_{X} of 200 KHz waveform signal, the pulse signal of K_{Z} is 400 KHz, i.e., the output signal will be reset to the reference level every 2.5 us. Provided that the forward gain of the charge amplifier is 0.1, and the working voltage of the charge amplifier is 2.8V, if the amplifier with the resetting element is not utilized, the amplitude of the output signal is theoretically 3V, which is 0.2V higher than the working voltage of the charge amplifier, and the charge amplifier will apparently be turned into the saturation state. By contrast, for the amplifier with the resetting element provided by the embodiment of the present invention, the output signal will be reset every 2.5 us, that is to say, the output of the charge amplifier will follow the input for 2.5 us at most, and then it will restart again. The output signal in theoretical is V_{OUT1}=0.1*30 sin(10K)=3 sin(10K*6.28), the maximum variation ratio of the output signal is 3*62.8K=188.4K, and the maximum variation of the output amplitude in 2.5 us is 2.5u*188.4K=471 mV. It can be seen that the output signal will not entry into the saturation region as long as the output signal is reset every 2.5 us.

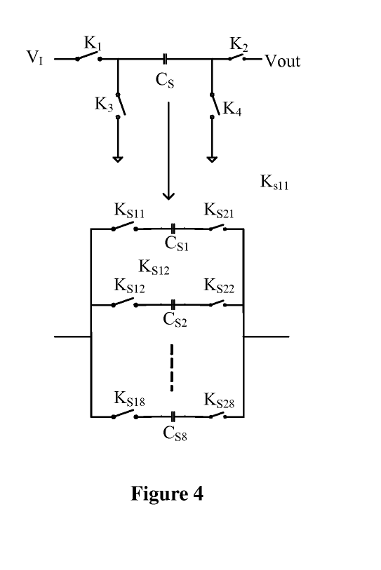

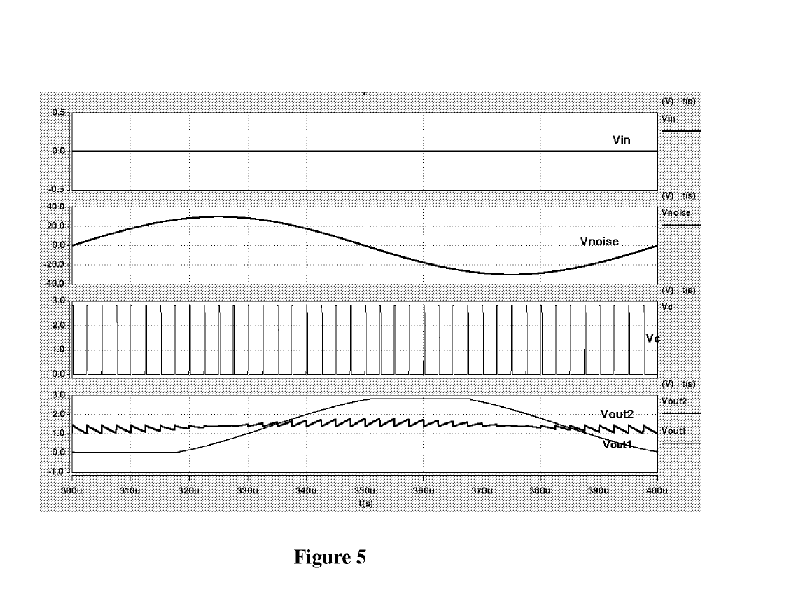

In an embodiment of the present invention, the charge amplifier converts the charges into a voltage signal which is sampled by the over-sampling and holding circuit, is windowed in continuous domain or in digital domain or sampling data domain by the weighting and filtering circuit, and then is converted into a digital signal by the analog-to-digital converter before being output. In an embodiment of the present invention, the over-sampling and holding circuit and the weighting and filtering circuit may be integrated in a single module as shown in FIG. 4, or may be implemented by separate circuits, which will not be limited herein. In FIG. 4, when K₁ and K₄ are closed and K₂ and K₃ are opened, the circuit performs the sampling, the quantity of the charges stored by C_{S} is C_{S}*V₁. When K₁ and K₃ are opened and K₂ and K₄ are closed, the charges stored in C_{S} are transferred to the next stage of circuit. Because T_{X} signal is a sequence of burst pulses, the output signal may be windowed, in order to decrease the influence of the signal restoration side lobes. Windowing is essentially to multiply the output signal by a coefficient or to amplitude-modulate the output signal. This multiplying may be performed in continuous domain, digital domain or sampling data domain. In the circuit, C_{S} may include 8 capacitors, for example C_{S1}˜C₅₈ as shown in FIG. 4, and the capacitors are connected by switches. Selection of different amount of C_{S}, means multiplying the output signal by different coefficients. For example, to select only one C_{Si}, the switches K_{S1i}, and K_{S2i}, are closed, and the coefficient is ⅛; to select 5 C_{Si}, means the coefficient is ⅝; if none is selected, the coefficient is 0; and if all are selected, the coefficient is 1.

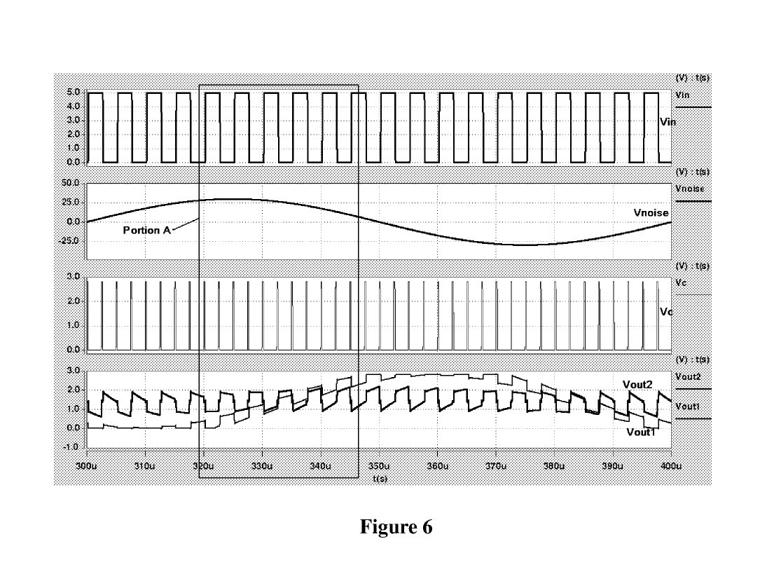

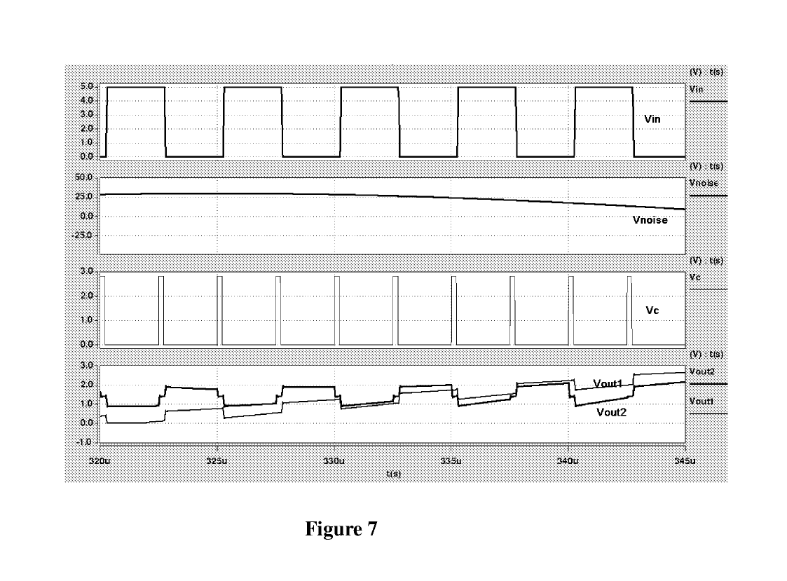

To describe in detail the effect of the touch detection method for capacitive touch screens of the present invention as compared to that of the prior art, experiments and simulations are performed as shown in FIG. 5. As shown in FIG. 5, the input signal Vin is 0, the noise signal Vnoise is a sine wave with an amplitude of 30V and a frequency of 10 KHz, the pulse wave of the resetting signal Vc has a frequency of 400 KHz, the high-level has a width of 300 ns, the output signal in the prior art is Vout1, and the output signal in the embodiment of the present invention is Vout2. As shown in FIG. 6, the input signal is a square wave with an amplitude of 5V and a frequency of 200 KHz, the noise signal is a sine wave with an amplitude of 30V and a frequency of 10 KHz, the pulse wave of the resetting signal Vc has a frequency of 400 KHz, the high-level has a width of 300 ns, the output signal in the prior art is Vout1, and the output signal in the embodiment of the present invention is Vout2. FIG. 7 is a partial schematic diagram of A portion in FIG. 6. It can be seen from the simulation diagrams of FIG. 5, FIG. 6 and FIG. 7 that the anti-noise performance of the touch detection method for capacitive touch screens provided by the present invention is superior to that in the prior art.

In the embodiments of the present invention, at arrival of the edge of the waveform signal, the capacitor under detection is charged and discharged, and the quantity of electric charges is transmitted to the detection circuit. Because the detection circuit resets the output signal to the reference level prior to the variation in the edge of the waveform signal, the accumulation of the noise signal can be avoided, the saturation of the output signal is decreased, and the anti-noise performance of the system is improved. Further, in implementing the touch detection method for the capacitive touch screens provided by the present invention, it is unnecessary to scan with three frequencies simultaneously, therefore the total detection time can be decreased, and no additional hardware cost is required. According to the method provided by the embodiment of the present invention, when a touch takes place, variation in the capacitance of the capacitor under detection will be caused. By detecting the variation, it may be determined whether the touch takes place, and if the touch takes place, the coordinates of the touch may be calculated.

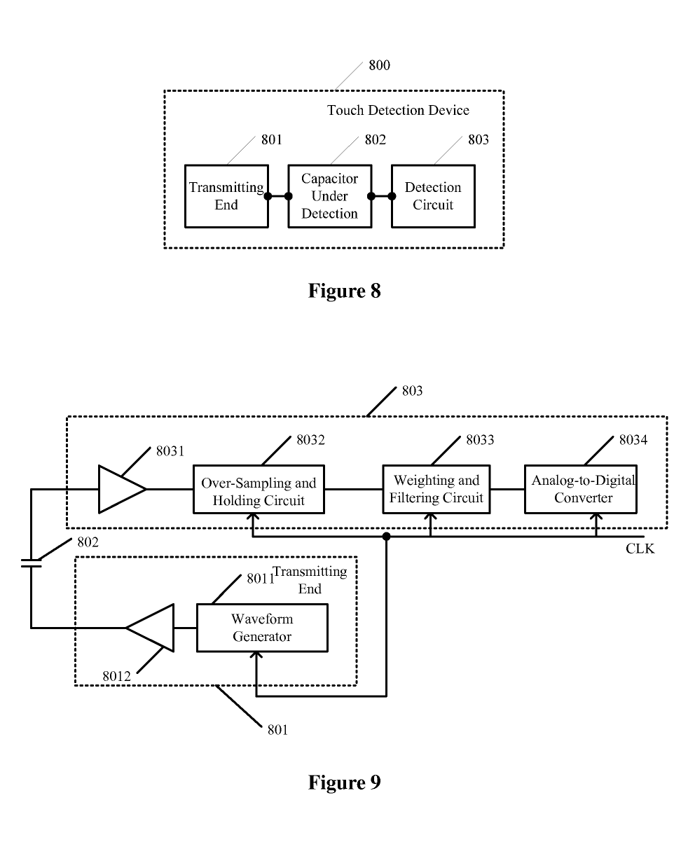

The above embodiments have described the touch detection method for capacitive touch screens provided by the present invention, and the touch detection device provided by the present invention will be described hereinafter. The touch detection device provided by the present invention may be built-in the capacitive touch screen, and the process of the touch detection may be implemented with software or hardware integration. In the embodiment of the present invention, the device corresponding to the method described in the above method embodiments will be described, reference may be made to the above method embodiments for the operations of individual units, and only the contents of the related units will be described herein. Referring to FIG. 8, the touch detection device 800 includes: a transmitting end 801, a capacitor under detection 802, and a detection circuit 803, where the phase clock of the detection circuit 803 and the phase clock of the transmitting end 801 are kept synchronous.

The transmitting end 801 is adapted to generate a waveform signal to be transmitted and transmit the waveform signal to the capacitor 802 under detection.

The capacitor 802 under detection is adapted to convert the waveform signal transmitted by the transmitting end 801 into charges, and transfer the charges to the detection circuit 803, where when a touch takes place, the capacitance of the capacitor 802 under detection is changed, and the quantity of the charges transferred to the detection circuit 803 is also changed.

The detection circuit 803 is adapted to receive the charges transferred by the capacitor 802 under detection, determine whether the touch takes place by performing detection processing on the output signal, and reset the output signal of the detection circuit to a reference level prior to a variation in an edge of the waveform signal.

As shown in FIG. 9, which is a schematic diagram of constitution structure of a touch detection device provided by an embodiment of the present invention, the phase clock of the transmitting end 801 and the phase clock of the detection circuit 803 are kept synchronous. In practice, for the transmitting end 801, one possible implementation is that the transmitting end 801 includes a waveform generator 8011 and a transmitter 8012.

The waveform generator 8011 is adapted to generate the waveform signal to be transmitted.

The transmitter 8012 is adapted to transmit the waveform signal to the capacitor under detection.

As shown in FIG. 9, which is a schematic diagram of constitution structure of a touch detection device provided by the embodiment of the present invention, in practice, for the detection circuit 803, one possible implementation is that the detection circuit 803 includes: a charge amplifier 8031 with a resetting element and a feedback capacitor, an over-sampling and holding circuit 8032, a weighting and filtering circuit 8033 and an analog-to-digital converter 8034.

The charge amplifier 8031 with the resetting element and the feedback capacitor is adapted to receive the charges transferred by the capacitor under detection, generate the output signal and reset the output signal to the reference level prior to the variation in the edge of the waveform signal.

The over-sampling and holding circuit 8032 is adapted to perform high-speed sampling and holding on the output signal.

The weighting and filtering circuit 8033 is adapted to window the output signal in continuous domain or in digital domain or sampling data domain

The analog-to-digital converter 8034 is adapted to convert the output signal into a digital signal and output the digital signal, to determine whether the touch takes place.

It is to be noted that information interaction between individual modules/units of the device and the procedure for the operation are of the same conception as the method of the present invention, and bring same technical effects as the method of the present invention. For specific illustration, reference may be made to the description in the method embodiment of the present invention as shown in FIG. 1, which will not be described in detail herein.

In the embodiments of the present invention, at arrival of the edge of the waveform signal, the capacitor under detection is charged and discharged, and the quantity of electric charges is transmitted to the detection circuit. Because the detection circuit resets the output signal to the reference level prior to the variation in the edge of the waveform signal, the accumulation of the noise signal can be avoided, the saturation of the output signal is decreased, and the anti-noise performance of the system is improved. Further, in implementing the touch detection method for the capacitive touch screens provided by the present invention, it is unnecessary to scan with three frequencies simultaneously, therefore the total detection time can be decreased, and no additional hardware cost is required. According to the method provided by the embodiment of the present invention, when a touch takes place, variation in the capacitance of the capacitor under detection will be caused. By detecting the variation, it may be determined whether the touch takes place, and if the touch takes place, the coordinates of the touch may be calculated.

Those skilled in the art may understand that all or some of the steps of the method may be implemented with related hardware by following instructions of a program which may be stored in a computer-readable storage medium, such as a read-only storage, a magnetic disk or an optical disk.

The touch detection method for capacitive touch screens and the touch detection device provided by the present invention have been described in details. However, modifications may be made to the specific embodiments and the applications by those skilled in the art within the idea of the present invention. To sum up, this specification should not be interpreted as a limit to the present invention.

What is claimed is:

1. A touch detection method for capacitive touch screens, comprising:
generating a waveform signal to be transmitted and transmitting the waveform signal to a capacitor under detection, by a transmitting end;
converting the waveform signal transmitted by the transmitting end into charges and transferring the charges to a detection circuit, by the capacitor under detection, wherein when a touch takes place, the capacitance of the capacitor under detection changes and a quantity of the charges transferred to the detection circuit also changes; and
receiving the charges transferred by the capacitor under detection, generating an output signal, determining whether the touch takes place by performing detection processing on the output signal, and resetting the output signal of the detection circuit to a reference level prior to a variation in an edge of the waveform signal, by the detection circuit, wherein a phase clock of the detection circuit and a phase clock of the transmitting end are kept synchronous.

2. The touch detection method for capacitive touch screens according to claim 1, wherein resetting the output signal of the detection circuit to a reference level prior to variation in an edge of the waveform signal by the detection circuit comprises:
closing and then opening a switch with a nanosecond-scale high-level pulse wave in a frequency higher than the frequency of the waveform signal prior to the variation in the edge of the waveform signal, by the detection circuit.

3. The touch detection method for capacitive touch screens according to claim 1, wherein performing detection processing on the output signal by the detection circuit comprises:
performing high-speed sampling and holding on the output signal, performing weighting and filtering on the sampled and hold signal, and converting the weighted and filtered signal into a digital signal, by the detection circuit, to determine whether the touch takes place.

4. The touch detection method for capacitive touch screens according to claim 3, wherein the weighting and filtering comprises:
windowing the output signal in continuous domain or in digital domain or in sampling data domain.

5. The touch detection method for capacitive touch screens according to claim 1, wherein the waveform signal comprises: any one of continuous square wave, continuous trapezoidal wave, continuous sine wave, continuous cosine wave, and continuous triangular wave.

6. A touch detection device comprising a transmitting end, a capacitor under detection, and a detection circuit, wherein:
the transmitting end is adapted to generate a waveform signal to be transmitted and transmit the waveform signal to the capacitor under detection;
the capacitor under detection is adapted to convert the waveform signal transmitted by the transmitting end into charges, and transfer the charges to the detection circuit, wherein when a touch takes place, the capacitance of the capacitor under detection changes and a quantity of the charges transferred to the detection circuit also changes; and
the detection circuit is adapted to receive the charges transferred by the capacitor under detection, generate an output signal, determine whether the touch takes place by performing detection processing on the output signal, and reset the output signal of the detection circuit to a reference level prior to a variation in an edge of the waveform signal, wherein a phase clock of the detection circuit and a phase clock of the transmitting end are kept synchronous.

7. The touch detection device according to claim 6, wherein the transmitting end comprises a waveform generator and a transmitter,
the waveform generator is adapted to generate the waveform signal to be transmitted; and
the transmitter is adapted to transmit the waveform signal to the capacitor under detection.

8. The touch detection device according to claim 6, wherein the detection circuit comprises a charge amplifier with a resetting element and a feedback capacitor, an over-sampling and holding circuit, a weighting and filtering circuit and an analog-to-digital converter, wherein:
the charge amplifier with the resetting element and the feedback capacitor is adapted to receive the charges transferred by the capacitor under detection, generate the output signal and reset the output signal to the reference level prior to the variation in the edge of the waveform signal;
the over-sampling and holding circuit is adapted to perform high-speed sampling and holding on the output signal;
the weighting and filtering circuit is adapted to window the output signal in continuous domain or in digital domain or in sampling data domain; and
the analog-to-digital converter is adapted to convert the output signal into a digital signal and output the digital signal, to determine whether the touch takes place.
